(19) United States
(12) Patent Application Publication
(10) Pub. No.: US 2005/0218351 A1
(43) Pub. Date: Oct. 6, 2005

(54) Meter capable of measuring ambient dust concentration

(76) Inventors: Bing Sheng, Hang-zhou (CN); Xiao-Yong Wang, Hang-zhou (CN); Li-Ming Lin, Hang-zhou (CN)

Correspondence Address: DLA PIPER RUDNICK GRAY CARY US, LLP, 2000 UNIVERSITY AVENUE, E. PALO ALTO, CA, 94303-2248, US

(21) Appl. No.: 10/923,367

(22) Filed: Aug. 20, 2004

(30) Foreign Application Priority Data
Apr. 1, 2004 (TW) 093109075

(51) Int. Cl. G01N 21/85

(52) U.S. Cl. 250/573

(57) ABSTRACT

A dust meter includes a duct member having a lower portion formed with an air inlet, and an upper portion formed with an air outlet, and confining an air passage. A heating element is used to heat air in the air passage to result in air flow from the air inlet to the air outlet. A light emitter is operable so as to generate a light beam in the air passage. An optical sensor module includes a light sensor responsive to changes in optical flux in the air passage attributed to dust content of the air that flows from the air inlet to the air outlet. The sensor module generates an electrical signal that varies with the optical flux detected by the light sensor. A processing circuit determines an actual ambient dust concentration by referring the electrical signal from the sensor module to pre-established data in the processing circuit.

### CROSS-REFERENCE TO RELATED APPLICATION

This application claims priority of Taiwanese application no. 093109075, filed on Apr. 1, 2004.

### BACKGROUND OF THE INVENTION

1. Field of the Invention

The invention relates to a meter capable of measuring ambient dust concentration.

2. Description of the Related Art

In a conventional high-precision dust meter, an air pump is operable so as to draw ambient air into a chamber at a predetermined rate. A filter paper is used to remove large particles from the air flowing into the chamber. A laser diode emits a laser beam in the chamber that is directed toward the path of the air drawn into the chamber. An optical particle counter then detects the ambient dust concentration either through detection of light scattering by dust particles entrained in the air drawn into the chamber, or through analysis of changes in optical flux attributed to light blocking by the dust particles entrained in the air drawn into the chamber.

The following are some of the drawbacks of the conventional high-precision dust meter:
1. Frequent replacement of the filter paper is needed to maintain the rate of air that flows into the chamber.

2. The air pump consumes a large amount of electric power, which can affect the service life of a portable dust meter, and is a source of noise in the work place.

3. Optical particle counting requires not only an expensive laser diode to ensure good light source quality, but also a highly sensitive and highly accurate light sensor, which unavoidably results in high production costs for the dust meter.

### SUMMARY OF THE INVENTION

Therefore, the object of the present invention is to provide a dust meter that can overcome the aforesaid drawbacks associated with the prior art.

Accordingly, the meter of this invention is capable of measuring ambient dust concentration, and comprises a duct member, a heating element, a light emitter, an optical sensor module, and a processing circuit.

The duct member has a lower portion formed with an air inlet, and an upper portion formed with an air outlet. The duct member confines an air passage that extends from the air inlet to the air outlet.

The heating element is disposed in the air passage proximate to the air inlet, and is operable so as to heat air in the air passage, thereby resulting in air flow from the air inlet to the air outlet.

The light emitter is disposed in the air passage, and is operable so as to generate a light beam.

The optical sensor module includes a light sensor disposed in the air passage and responsive to changes in optical flux in the air passage attributed to dust content of the air that flows from the air inlet to the air outlet. The optical sensor module generates an electrical signal that varies with the optical flux detected by the light sensor.

The processing circuit is coupled to the optical sensor module, and is capable of determining an actual ambient dust concentration by referring the electrical signal from the optical sensor module to pre-established data in the processing circuit.

### BRIEF DESCRIPTION OF THE DRAWINGS

Other features and advantages of the present invention will become apparent in the following detailed description of the preferred embodiment with reference to the accompanying drawings, of which:

FIG. 1 is a front view of the preferred embodiment of a dust meter according to the present invention;

FIG. 2 is a rear perspective view of the preferred embodiment;

FIG. 3 is a rear perspective view of a measuring unit of the preferred embodiment;

FIG. 4 is a schematic circuit block diagram of the preferred embodiment; and

FIG. 5 is a plot to illustrate an exemplary pre-established relation between an output of an optical sensor module and actual ambient dust concentration.

### DETAILED DESCRIPTION OF THE PREFERRED EMBODIMENT

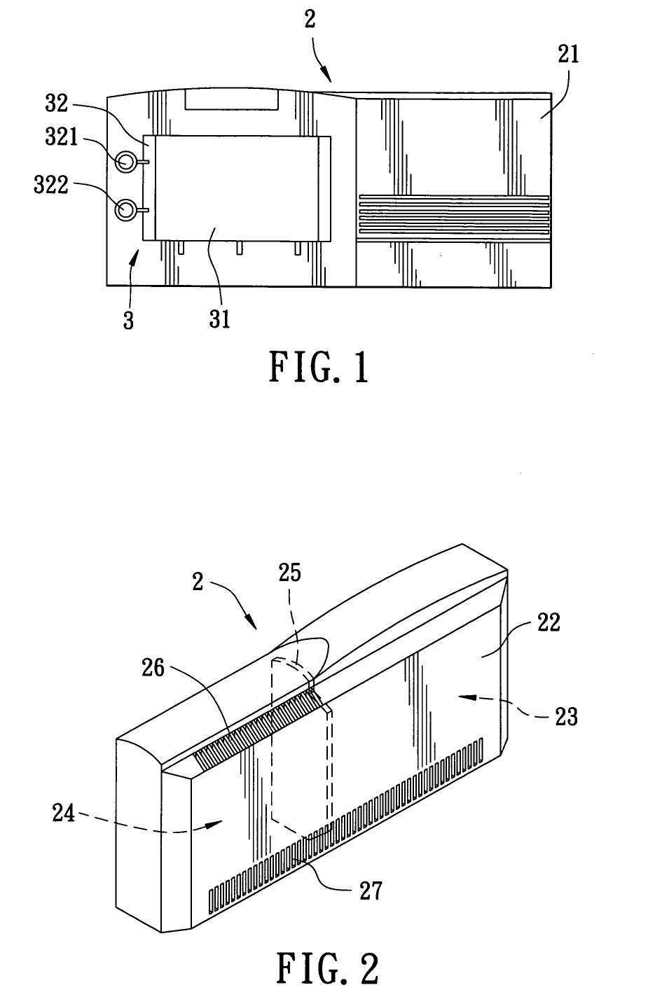

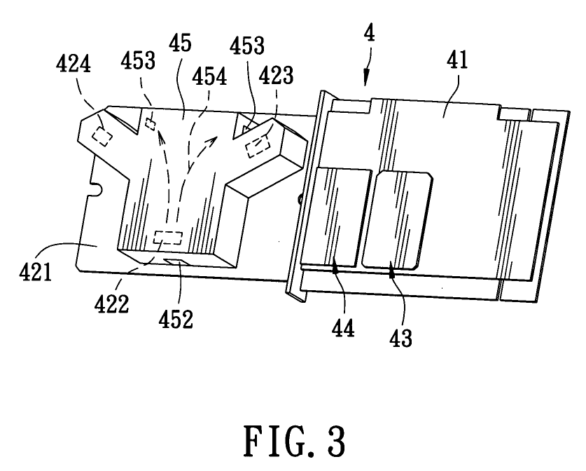

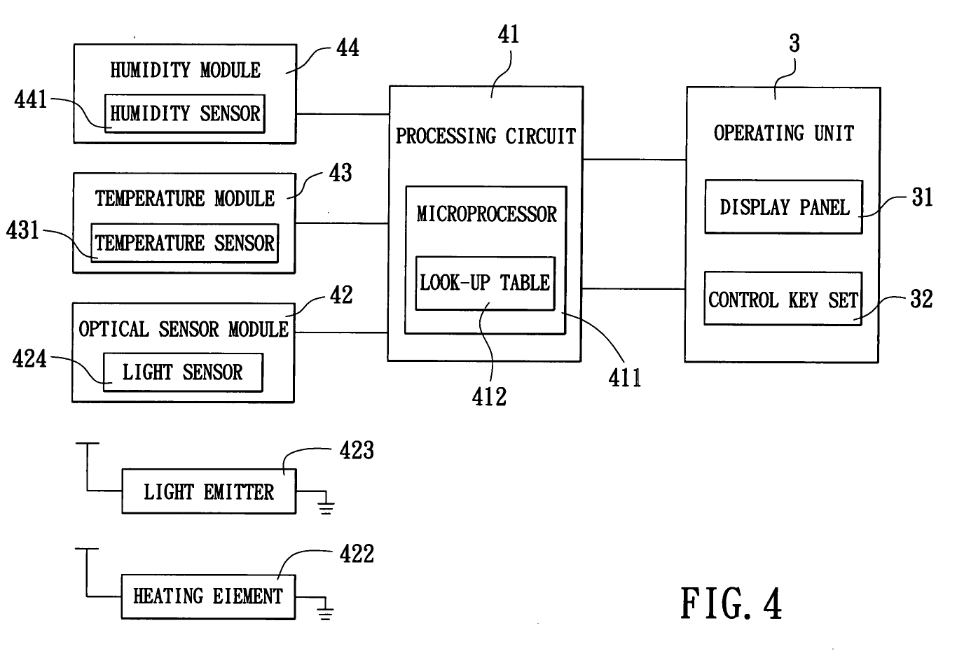

Referring to FIGS. 1 to 4, the preferred embodiment of a dust meter according to the present invention is shown to include a housing 2, a measuring unit 4 disposed in the housing 2, and an operating unit 3 mounted on the housing 2 and connected electrically to the measuring unit 4.

The housing 2 has a front operating side 21, a rear side 22 opposite to the front operating side 21, and a partition 25 to divide an interior of the housing 2 into a first chamber 24 and a second chamber 23. The rear side 22 of the housing 2 has a top portion formed with a set of first vent holes 26 in fluid communication with the first chamber 24, and a bottom portion formed with a set of second vent holes 27 in fluid communication with the first and second chambers 24, 23.

The measuring unit 4 includes a duct member 45, a base board 421, a heating element 422, a light emitter 423, an optical sensor module 42, a processing circuit 41, a temperature module 43, and a humidity module 44.

The duct member 45 has a lower portion formed with an air inlet 452, and an upper portion formed with a set of air outlets 453. The duct member 45 confines an air passage 454 that extends from the air inlet 452 to the air outlets 453. The first and second vent holes 26, 27 are in fluid communication with the air outlets 453 and the air inlet 452 of the duct member 45, respectively. In this embodiment, the duct member 45 has an open side, and is mounted on the base board 421 such that the base board 421 closes the open side of the duct member 45 and such that the base board 421 and the duct member 45 cooperatively confine the air passage 454.

The heating element 422 is disposed in the air passage 454 proximate to the air inlet 452, and is operable so as to heat air in the air passage 454, thereby resulting in air flow from the air inlet 452 to the air outlets 453. In this embodiment, the heating element 422 includes a power resistor.

The light emitter 423 is disposed in the air passage 454, and is operable so as to generate a light beam. In this embodiment, the light emitter 423 includes a light emitting diode.

The optical sensor module 42 includes a light sensor 424 disposed in the air passage 454 opposite to the light emitter 423 and responsive to changes in optical flux in the air passage 454 attributed to dust content of the air that flows from the air inlet 452 to the air outlets 453. The optical sensor module 42 generates an electrical signal that varies with the optical flux detected by the light sensor 424. The light sensor 424 may be a photo diode or a light-sensitive resistor. The heating element 422, the light emitter 423, and the light sensor 424 are mounted on the base board 421, and extend into the air passage 454 via the open side of the duct member 45. Because the air passage 454 is a dark space, and because the light emitter 423 and the light sensor 424 are disposed in the air passage 454, interference due to ambient light can be avoided.

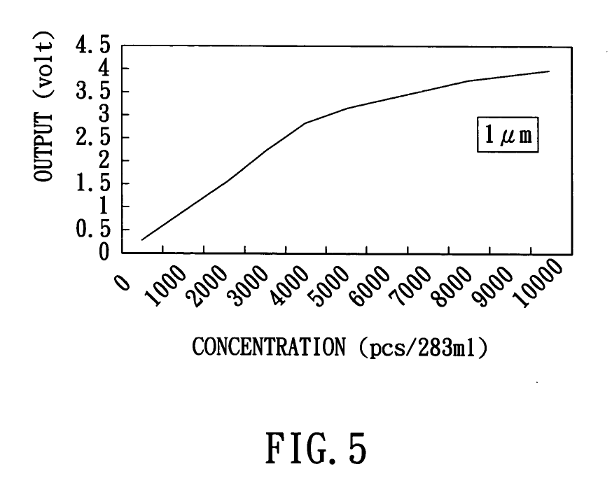

The processing circuit 41 is coupled to the optical sensor module 42, is mounted on the base board 421, and is disposed externally of the air passage 454. The processing circuit 41 includes a microprocessor 411 having pre-established data residing therein. In this embodiment, the pre-established data is a look-up table 412 that defines relations (see FIG. 5) between different values of electrical signals and different ambient dust concentrations.

The temperature module 43 is mounted on the baseboard 421, and is coupled electrically to the processing circuit 41. The temperature module 43 includes a temperature sensor 431, such as a thermistor, and generates a temperature signal that corresponds to ambient temperature sensed by the temperature sensor 431 and that is provided to the processing circuit 41.

The humidity module 44 is mounted on the base board 421, and is coupled electrically to the processing circuit 41. The humidity module 44 includes a humidity sensor 441, such as a humidity-sensitive resistor, and generates a humidity signal that corresponds to ambient humidity sensed by the humidity sensor 441 and that is provided to the processing circuit 41.

When the measuring unit 4 is disposed in the housing 2, the duct member 45 is located in the first chamber 24, whereas the processing circuit 41, the temperature module 43 and the humidity module 44 are located in the second chamber 23.

The operating unit 3 is mounted on the front operating side 21 of the housing 2, and includes a display panel 31 and a control key set 32, which are coupled electrically to the processing circuit 41. The control key set 32 includes a power key 321 that is operable so as to activate and deactivate selectively the processing circuit 41 in a known manner, and a function switch key 322 that is operable so as to select operation of the processing circuit 41 in one of a dust measuring mode, a temperature measuring mode, and a humidity measuring mode.

When operated in the dust measuring mode, the processing circuit 41 determines an actual ambient dust concentration by referring the electrical signal from the optical sensor module 42 to the look-up table 412 in the microprocessor 411, and controls the display panel 31 to provide a visible indication of the actual ambient dust concentration thereon.

When operated in the temperature measuring mode, the processing circuit 41 determines an actual ambient temperature from the temperature signal generated by the temperature module 43, and controls the display panel 31 to provide a visible indication of the actual ambient temperature thereon.

When operated in the humidity measuring mode, the processing circuit 41 determines an actual ambient humidity from the humidity signal generated by the humidity module 44, and controls the display panel 31 to provide a visible indication of the actual ambient humidity thereon.

To build up the pre-established data in the processing circuit 41, the dust meter of this invention is placed, together with a conventional high-precision dust meter, such as model number KC-03A1 available from RION Corp. of Japan, in several test rooms having different controlled ambient dust concentrations. During the data-establishing procedure, the optical sensor module 42 outputs electrical signals of varying magnitude in response to the different ambient dust concentrations, thereby resulting in the plot shown in FIG. 5 from which the look-up table 412 can be established.

The following are some of the advantages of the meter of this invention:
1. The heating element 422 is less expensive and consumes less electric power as compared to an air pump, and does not generate noise that can pollute the work place.
2. The meter of this invention involves comparison of electric signals corresponding to detected optical flux with pre-established data in the processing circuit 41. The pre-established data can be easily duplicated at a low cost for use by a batch of the meters according to this invention. Moreover, since the pre-established data were built with the use of a high-precision dust meter, the results obtained with the use of the meter of this invention are reliable.
3. Since the meter of this invention does not utilize optical particle counting techniques to determine the ambient dust concentration, the stringent requirements for a laser diode and a highly sensitive and highly accurate light sensor commonly encountered in the prior art may be dispensed with.

It is thus evident from the foregoing that the meter according to this invention is suitable for mass production at a relatively low cost, and is appropriate for a wide range of applications.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A meter capable of measuring ambient dust concentration, comprising:
a duct member having a lower portion formed with an air inlet, and an upper portion formed with an air outlet, said duct member confining an air passage that extends from said air inlet to said air outlet;
a heating element disposed in said air passage proximate to said air inlet, and operable so as to heat air in said air passage, thereby resulting in air flow from said air inlet to said air outlet;
a light emitter disposed in said air passage and operable so as to generate a light beam;
an optical sensor module including a light sensor disposed in said air passage and responsive to changes in optical flux in said air passage attributed to dust content of the air that flows from said air inlet to said air outlet, said optical sensor module generating an electrical signal that varies with the optical flux detected by said light sensor; and
a processing circuit coupled to said optical sensor module and capable of determining an actual ambient dust concentration by referring the electrical signal from said optical sensor module to pre-established data in said processing circuit.

2. The meter as claimed in claim 1, wherein said pre-established data is a look-up table that defines relations between different values of electrical signals and different ambient dust concentrations, said look-up table being resident in said processing circuit.

3. The meter as claimed in claim 1, wherein said heating element includes a power resistor.

4. The meter as claimed in claim 1, wherein said light emitter includes a light emitting diode.

5. The meter as claimed in claim 1, wherein said light sensor includes a photo diode.

6. The meter as claimed in claim 1, wherein said light sensor includes a light-sensitive resistor.

7. The meter as claimed in claim 1, further comprising a base board,
said duct member having an open side and being mounted on said base board such that said base board closes said open side of said duct member and such that said base board and said duct member cooperatively confine said air passage,
said heating element, said light emitter and said light sensor being mounted on said base board and extending into said air passage via said open side of said duct member.

8. The meter as claimed in claim 7, wherein said processing circuit is mounted on said base board and is disposed externally of said air passage.

9. The meter as claimed in claim 1, further comprising a housing to contain said duct member, said housing being formed with vent holes that are in fluid communication with said air inlet and said air outlet of said duct member.

10. The meter as claimed in claim 9, further comprising an operating unit mounted on said housing and including a display panel coupled to said processing circuit,
said processing circuit being operable in a dust measuring mode, in which said processing circuit controls said display panel to provide a visible indication of the actual ambient dust concentration thereon.

11. The meter as claimed in claim 10, wherein said housing is provided with a partition to divide an interior of said housing into a first chamber and a second chamber, said duct member being disposed in said first chamber, said processing circuit being disposed in said second chamber.

12. The meter as claimed in claim 11, further comprising a temperature module disposed in said second chamber and coupled electrically to said processing circuit, and a humidity module disposed in said second chamber and coupled electrically to said processing circuit.

13. The meter as claimed in claim 12, wherein:
said temperature module includes a temperature sensor and generates a temperature signal that corresponds to ambient temperature sensed by said temperature sensor and that is provided to said processing circuit, and
said humidity module includes a humidity sensor and generates a humidity signal that corresponds to ambient humidity sensed by said humidity sensor and that is provided to said processing circuit.

14. The meter as claimed in claim 13, wherein said processing circuit is further operable in one of a temperature measuring mode and a humidity measuring mode,
said processing circuit determining an actual ambient temperature from the temperature signal, and controlling said display panel to provide a visible indication of the actual ambient temperature thereon when operated in the temperature measuring mode,
said processing circuit determining an actual ambient humidity from the humidity signal, and controlling said display panel to provide a visible indication of the actual ambient humidity thereon when operated in the humidity measuring mode.

15. The meter as claimed in claim 14, wherein said operating unit further includes a control key set coupled electrically to said processing circuit, said control key set including a function switch key operable so as to select operation of said processing circuit in one of the dust measuring mode, the temperature measuring mode and the humidity measuring mode.

16. The meter as claimed in claim 15, wherein said control key set further includes a power key operable so as to activate and deactivate selectively said processing circuit.
